(19) United States
(12) Patent Application Publication
(10) Pub. No.: US 2010/0013763 A1
(43) Pub. Date: Jan. 21, 2010

(54) METHOD AND APPARATUS FOR TOUCHLESS INPUT TO AN INTERACTIVE USER DEVICE

(75) Inventors: Paul Futter, Cary, NC (US); William O. Camp, JR., Chapel Hill, NC (US); Karin Johanne Spalink, Durham, NC (US); Ivan Nelson Wakefield, Cary, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB

(21) Appl. No.: 12/173,114

(22) Filed: Jul. 15, 2008

(51) Int. Cl. G06F 3/033

(52) U.S. Cl. 345/158

(57) ABSTRACT

A plurality of light sources is mounted on a housing of an interactive user device. The sources are spaced from each other in a defined spatial relationship, for example in a linear configuration. At least one light sensor is also positioned at the surface of the housing. The light sensor senses light that is reflected from an object placed by the user, such as the user's finger, within an area of the light generated by the light sources. A processor in the user device can recognize the sensed reflected light as a user input command correlated with a predefined operation and respond accordingly to implement the operation.

### FIELD OF THE INVENTION

The present invention relates to interactive user devices, more particularly to providing for touchless user input to such devices.

### BACKGROUND

Mobile communication devices, such as cellular phones, laptop computers, pagers, personal communication system (PCS) receivers, personal digital assistants (PDA), and the like, provide advantages of ubiquitous communication without geographic or time constraints. Advances in technology and services have also given rise to a host of additional features beyond that of mere voice communication including, for example, audio-video capturing, data manipulation, electronic mailing, interactive gaming, multimedia playback, short or multimedia messaging, web browsing, etc. Other enhancements, such as location-awareness features, e.g., satellite positioning system (SPS) tracking, enable users to monitor their location and receive, for instance, navigational directions.

The focus of the structural design of mobile phones continues to stress compactness of size, incorporating powerful processing functionality within smaller and slimmer phones. Convenience and ease of use continue to be objectives for improvement, extending, for example, to development of hands free operation. Users may now communicate through wired or wireless headsets that enable users to speak with others without having to hold their mobile communication devices to their heads. Device users, however, must still physically manipulate their devices. The plethora of additional enhancements increases the need for user input that is implemented by components such as keypad and joystick type elements. As these elements become increasingly smaller in handheld devices, their use can become cumbersome. In addition, development of joy stick mechanics and display interaction for these devices has become complex and these elements more costly.

Accordingly, a need exists for a more convenient and less expensive means for providing user input to an interactive user device.

### DISCLOSURE

The above described needs are fulfilled, at least in part, by mounting a plurality of light sources spaced from each other in a defined spatial relationship, for example in a linear configuration, on a surface of an interactive user device. At least one light sensor is also positioned at the surface of the housing. The light sensor senses light that is reflected from an object placed by the user, such as the user's finger, within an area of the light generated by the light sources. A processor in the user device can recognize the sensed reflected light as a user input command correlated with a predefined operation and respond accordingly to implement the operation.

The interactive device, for example, may be a mobile phone or other hand held device. The predefined operation may relate to any function of the device that is normally responsive to user input. Thus, a viable alternative is provided for keypad, joystick and mouse activation. This alternative is not limited to handheld devices as it is applicable also to computer systems.

Each of the light sources preferably exhibits an identifiable unique characteristic. For example, the light sources may comprise LED's of different colors or emanate signals of different pulse rates. The light sensor can identify components of the reflected light with corresponding sources. The relative magnitudes of the one or more components are used as an indication of the position, in single dimension or two-dimension, of the user object. The position is correlated by the processor with a predefined device operation. Each light source may have an outer layer of film through which a unique image can be projected. The projected image may aid the user for positioning the user object.

The position of the user object may be linked to the device display. For example, one or more of the predetermined operations may be displayed as a menu listing. A listed element may be highlighted in the display as the user's object attains the spatial position associated with the element. Selection of a particular input may be completed by another user input, such as an audible input sensed by a microphone or a capacitive sensor, to trigger the operation by the processor.

A plurality of light sensors may be mounted on the housing surface. The number of sensors may be equal in number to the number of sources and positioned in a defined spatial relationship with respective sources, for example, linearly configured and in longitudinal alignment with the sources. As the position of the user object is in proximity to the light sensor (and its paired light source) that detects the greatest amount of reflected light, the processor can correlate the relative linear position of the light source with a predefined device operation. This exemplified configuration of sources and sensors also can be used to track real time movement of the user object. For example, a sweep of the user's finger across the light beams generated by a particular plurality of adjacent sources can be correlated to device function (for example, terminating a call), while the sweep across a different plurality of light beams can be correlated with a different device function.

The light sources and photo-sensors preferably are mounted on a side surface of the device housing. The user can then place the device on a table or countertop easily within reach of the user's hand. A retractable template can be provided at the bottom of the device. The template may be imprinted with a plurality of two-dimensional indicia on its upper surface. The template can be extended laterally from the housing to lie flat on the surface supporting the housing. Each of the indicia can be correlated with a device function, as a guide for the appropriate positioning of the user's finger. The template may be coupled electrically to the processor so that touching one of the indicia will trigger the photo sensing operation. For example, at each of the indicia a switch may be operable by depression of the user's finger to signal the processor. Alternatively, a capacitive sensor may be employed.

When fully extended, each of the indicia may represent a text entry, similar to an English language keyboard. When extended to a different position, the template may represent text entry for a different language or, instead, a plurality of different input commands. Correlation of indicia positions with device operations for different lengths of template extension may be stored in the memory of the device.

The position of the user object in both the two-dimensional lateral and longitudinal components can be determined by the processor in response to the input data received from the plurality of sensors. The distance in the lateral direction, i.e., the direction parallel to the housing surface, can be determined based on the relative magnitudes of light sensed among the light sensors. The distance in the longitudinal direction, i.e., the direction perpendicular to the housing surface, also can be determined based on the relative magnitudes of the totality of the sensed reflected light.

### BRIEF DESCRIPTION OF THE DRAWINGS

The present invention is illustrated by way of example, and not by way of limitation, in the figures of the accompanying drawing and in which like reference numerals refer to similar elements and in which:

FIG. 1 is a block diagram of an interactive user device, exemplified as a mobile communication device;

FIG. 2 is a perspective view of a configuration including a plurality of light sources with corresponding photo-sensors.

FIG. 3 is a variation of the configuration shown in FIG. 2.

FIG. 4 is a plan view of a configuration such as shown in FIG. 2 illustrative of one mode of operation.

FIG. 5 is a plan view of a configuration such as shown in FIG. 2 with additional modification.

FIG. 6 is a flow chart exemplifying one mode of operation.

### DETAILED DESCRIPTION

In the following description, for purposes of explanation, numerous specific details are set forth in order to provide a thorough understanding of exemplary embodiments. It should be appreciated that exemplary embodiments may be practiced without these specific details or with an equivalent arrangement. In other instances, well-known structures and devices are shown in block diagram form in order to avoid unnecessarily obscuring exemplary embodiments.

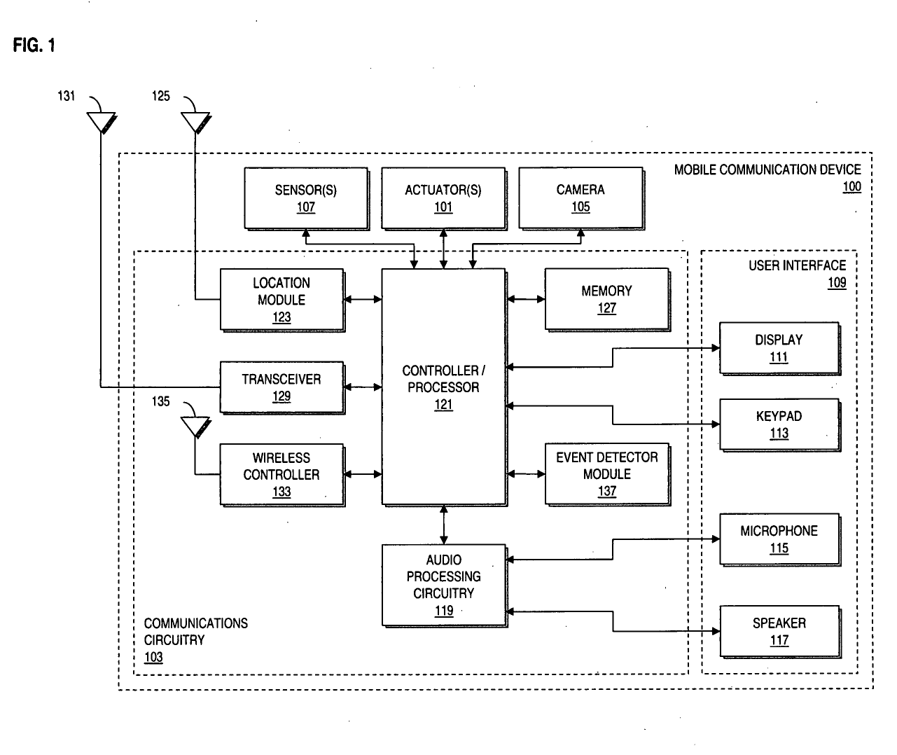

FIG. 1 is a block diagram of a mobile communication device such as a mobile phone. In this example, mobile communication device 100 includes one or more actuators 101, communications circuitry 103, camera 105, one or more sensors 107, and user interface 109. While specific reference will be made thereto, it is contemplated that mobile communication device 100 may embody many forms and include multiple and/or alternative components.

User interface 109 includes display 111, keypad 113, microphone 115, and speaker 117. Display 111 provides a graphical interface that permits a user of mobile communication device 100 to view call status, configurable features, contact information, dialed digits, directory addresses, menu options, operating states, time, and other service information, such as physical configuration policies associating triggering events to physical configurations for automatically modifying a physical configuration of mobile communication device 100, scheduling information (e.g., date and time parameters) for scheduling these associations, etc. The graphical interface may include icons and menus, as well as other text, soft controls, symbols, and widgets. In this manner, display 111 enables users to perceive and interact with the various features of mobile communication device 100.

Keypad 113 may be a conventional input mechanism. That is, keypad 113 may provide for a variety of user input operations. For example, keypad 113 may include alphanumeric keys for permitting entry of alphanumeric information, such as contact information, directory addresses, phone lists, notes, etc. In addition, keypad 113 may represent other input controls, such as a joystick, button controls, dials, etc. Various portions of keypad 113 may be utilized for different functions of mobile communication device 100, such as for conducting voice communications, SMS messaging, MMS messaging, etc. Keypad 113 may include a “send” key for initiating or answering received communication sessions, and an “end” key for ending or terminating communication sessions. Special function keys may also include menu navigation keys, for example, for navigating through one or more menus presented via display 111, to select different mobile communication device functions, profiles, settings, etc. Other keys associated with mobile communication device 100 may include a volume key, an audio mute key, an on/off power key, a web browser launch key, a camera key, etc. Keys or key-like functionality may also be embodied through a touch screen and associated soft controls presented via display 111.

Microphone 115 converts spoken utterances of a user into electronic audio signals, while speaker 117 converts audio signals into audible sounds. Microphone 115 and speaker 117 may operate as parts of a voice (or speech) recognition system. Thus, a user, via user interface 109, can construct user profiles, enter commands, generate user-defined policies, initialize applications, input information (e.g., physical configurations, scheduling information, triggering events, etc.), and select options from various menu systems of mobile communication device 100.

Communications circuitry 103 enables mobile communication device 100 to initiate, receive, process, and terminate various forms of communications, such as voice communications (e.g., phone calls), SMS messages (e.g., text and picture messages), and MMS messages. Communications circuitry 103 can enable mobile communication device 100 to transmit, receive, and process data, such as endtones, image files, video files, audio files, ringbacks, ringtones, streaming audio, streaming video, etc. The communications circuitry 103 includes audio processing circuitry 119, controller (or processor) 121, location module 123 coupled to antenna 125, memory 127, transceiver 129 coupled to antenna 131, and wireless controller 133 (e.g., a short range transceiver) coupled to antenna 135.

Wireless controller 133 acts as a local wireless interface, such as an infrared transceiver and/or a radio frequency adaptor (e.g., Bluetooth adapter), for establishing communication with an accessory, hands-free adapter, another mobile communication device, computer, or other suitable device or network.

Processing communication sessions may include storing and retrieving data from memory 127, executing applications to allow user interaction with data, displaying video and/or image content associated with data, broadcasting audio sounds associated with data, and the like. Accordingly, memory 127 may represent a hierarchy of memory, which may include both random access memory (RAM) and read-only memory (ROM). Computer program instructions, such as “automatic physical configuration” application instructions, and corresponding data for operation, can be stored in non-volatile memory, such as erasable programmable read-only memory (EPROM), electrically erasable programmable read-only memory (EEPROM), and/or flash memory; however, may be stored in other types or forms of storage. Memory 127 may be implemented as one or more discrete devices, stacked devices, or integrated with controller/processor 121. Memory 127 may store program information, such as one or more user profiles, one or more user defined policies, one or more triggering events, one or more physical configurations, scheduling information, etc. In addition, system software, specific device applications, program instructions, program information, or parts thereof, may be temporarily loaded to memory 127, such as to a volatile storage device, e.g., RAM. Communication signals received by mobile communication device 100 may also be stored to memory 127, such as to a volatile storage device.

Controller/processor 121 controls operation of mobile communication device 100 according to programs and/or data stored to memory 127. Control functions may be implemented in a single controller (or processor) or via multiple controllers (or processors). Suitable controllers may include, for example, both general purpose and special purpose controllers, as well as digital signal processors, local oscillators, microprocessors, and the like. Controller/processor 121 may also be implemented as a field programmable gate array (FPGA) controller, reduced instruction set computer (RISC) processor, etc. Controller/processor 121 may interface with audio processing circuitry 119, which provides basic analog output signals to speaker 117 and receives analog audio inputs from microphone 115.

Controller/processor 121, in addition to orchestrating various operating system functions, can also enable execution of software applications. One such application can be triggered by event detector module 137. Event detector 137 is responsive to a signal from the user to initiate processing data received from sensors, as to be more fully described below. The processor implements this application to determine the spatial location of the user object and to identify a user input command associated therewith.

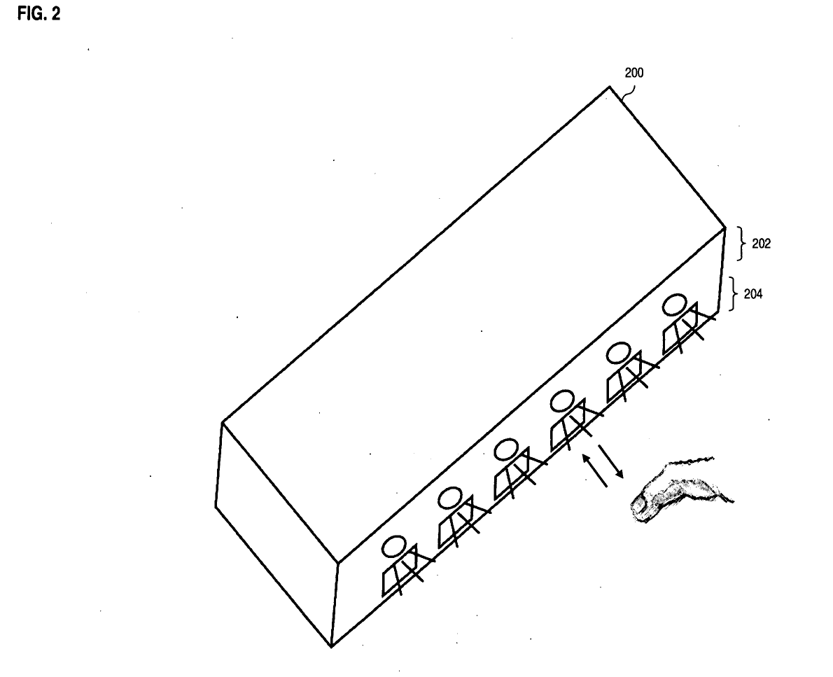

FIG. 2 is a perspective view of a housing 200 of an interactive device, such as the communication device exemplified in FIG. 1. A lower surface of the housing may be placed to rest on a planar support surface, such as a table, desk or counter. Mounted on the side surface of the housing is a linear array of six light sources 202 and a corresponding linear array of six photo-sensors 204. The sources may comprise, for example, light emitting diodes (LEDs). As shown, each light source is in relative vertical alignment on the side surface of the housing.

Illustrated in the drawing figure is a user's finger placed in proximity to the fourth vertically aligned pair of light source and photo-sensor. The position of the user's hand represents the selection by the user of a specific input command to be transmitted to the processor. As shown, the light generated by the source of this pair is reflected back to the photo-sensor of the pair. In lieu of using a finger for input selection, the user may use any object dimensioned to provide appropriate overlap of a single generated light beam. Data received from the plurality of photo-sensors are processed to determine which photo-sensor has the strongest response to light generated by the LEDs. As the sensed reflected light is unique to the fourth light source in this example, the linear position of the user object can be determined by the processor by evaluating the relative strengths of the received photo-sensor inputs. The processor can then access a database that relates position to predefined operation input selections.

As described, the user selection is implemented by sensing a static placement of the object in the vicinity of a photo-sensor. As the user's finger or object must be moved to the desired position to effect the command selection, provision may be made to prevent reading of the sensor outputs until the user object has attained the intended position. Such provision may be implemented by triggering reading of the sensor outputs in response to an additional criterion. Such criterion may comprise, for example, an audible input to the device microphone. Such input may be a voice command or an audible tapping of the support surface when the object has reached its intended position. Another such input may be a change in sensed capacitance when the user object is placed sufficiently close to the housing.

The embodiment of FIG. 2 may also be operated in a dynamic mode. The user's finger or other object may be moved over time across the path of a plurality of the light beams. Such movement can be tracked to provide the processor with a corresponding time sequence of sources and, thus, object positions. Specific user interface commands can be mapped in memory to respective various combinations of position sequences. For example, a finger sweep across all light beams may be translated to a command for terminating a call.

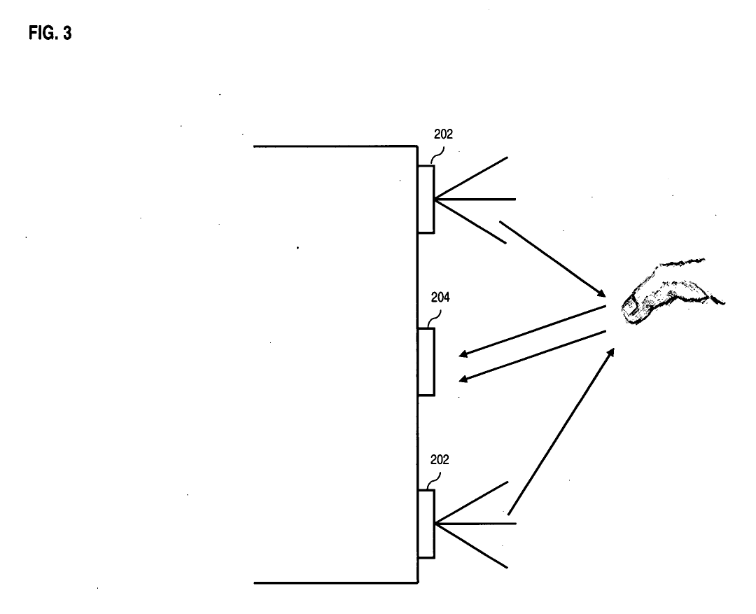

FIG. 3 is a variation of the configuration shown in FIG. 2, wherein light from fewer sources reflects from the user object to fewer sensors. The light sources, which may comprise LEDs, are uniquely encoded. For example, the LEDs may be of different colors or may produce light signals of different pulse widths. Light sensed by the photo-sensors thus may be identified with respective sources. The processor can access a database that correlates light beam characteristics with the light sources.

Specifically illustrated are two sources 202 located near respective ends of the housing. Sensor 204 is located near the center of the housing. The user's finger is positioned intermediate the two sources in the vertical (or lateral) direction, somewhat closer to the upper source. The light reflected from the object to the photo sensor 204 comprises a beam generated by the upper source and a beam generated by the lower source. As the object (finger) is closer to the upper source, its reflected beam will be of greater amplitude than the beam reflected by the lower source. The lateral position of the object along-side the device can be determined by evaluating the relative strengths of the light received by sensor 204. The beam components are distinguishable by virtue of their unique characteristics.

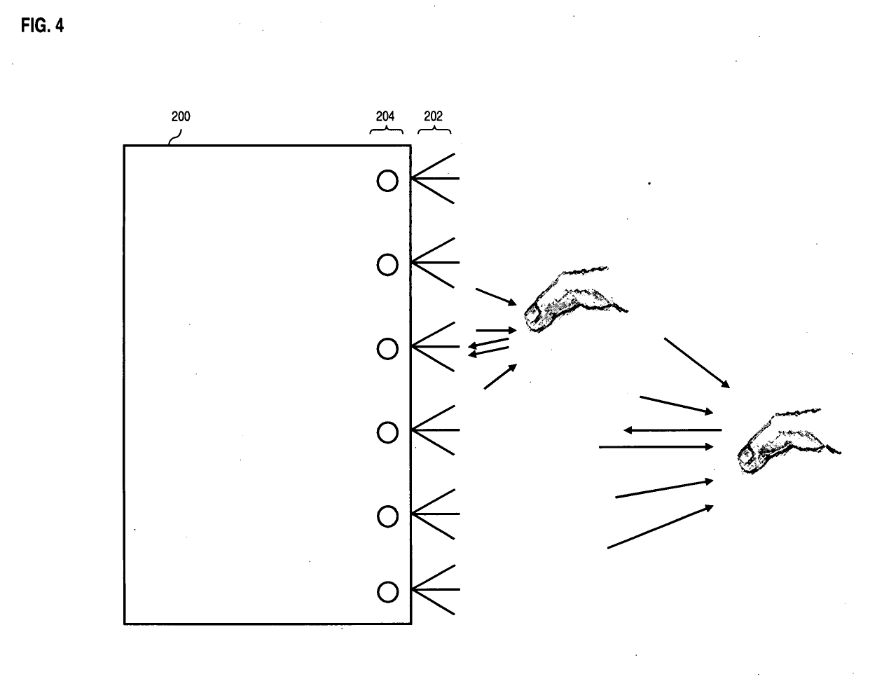

FIG. 4 is illustrative of an operational mode in which the two-dimensional position of the object can be determined using a configuration of light sources and photo-sensors such as shown in FIG. 2. The user's finger is depicted in a first position that is relatively close to the housing and a second position that is further from the housing. In the first position, as the object is close in the longitudinal (horizontal) direction, only a few light source reflections will reach the third photo-sensor 204. Three such beams are illustrated, the reflected beam of the closest source being the strongest of the three. In the second position, as the object is further away, more light source reflections, including weaker reflected beams, will arrive at the third photo-sensor 204. Weak reflected beams from some of the sources may also reach the second and fourth photo-sensors. The processor can evaluate the relative strengths of all reflected beams while identifying received data with the respective photo-sensors. This evaluation can determine the object location in the lateral direction (parallel to the housing edge) as well as its distance from the phone edge, i.e., the object location in the longitudinal direction.

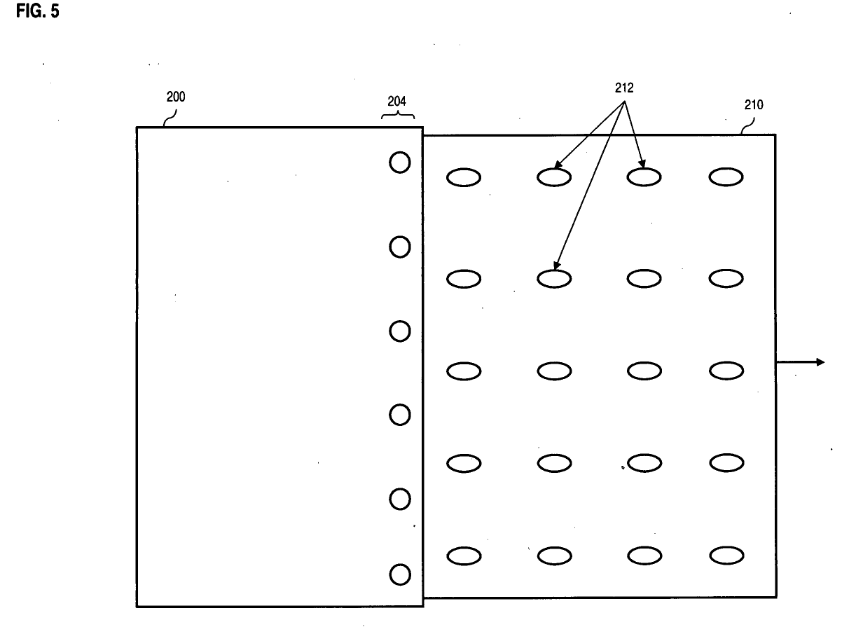

With the aid of the arrangement shown in FIG. 5, the user can take advantage of the multitude of possible commands made available by two-dimension position recognition, discussed with respect to FIG. 4. Although the sensors are not shown in FIG. 5, the configuration of sources and photo-sensors, relative to each other, may be the same as illustrated in FIG. 2. FIG. 5 is a top view of the housing at rest on a support surface. Template 210 is retractably coupled to the housing 200 near its bottom. Shown in a position extended from the housing, as indicated by the arrow, the template 210 can lie flat on the support surface to ease user implementation. The template can be retracted in the direction opposite the arrow to be encompassed by the housing when not in use.

The template 210 is imprinted with a plurality of indicia 212 on its upper surface. As illustrated, the indicia are exemplified by a two-dimensional spaced array in rows and columns. The indicia may be images of icons that are recognizable by the user. The two-dimensional position of each of the indicia can be correlated with a device function and serve as a guide for the appropriate positioning of the user's finger. The template may be coupled electrically to the processor so that touching one of the indicia will trigger the photo sensing operation. For example, at each of the indicia a switch may be operable by depression of the user's finger to signal the processor. Alternatively, a capacitive sensor may be employed.

The template may be utilized in a plurality of extended positions, the indicia representing a different set of commands for each extended position. For example, when fully extended, each of the indicia may represent a text entry, similar to an English language keyboard. When extended to a different position, the template may represent text entry for a different language or, instead, a plurality of different input commands. Correlation of indicia positions with device operations for different lengths of template extension may be stored in the memory of the device.

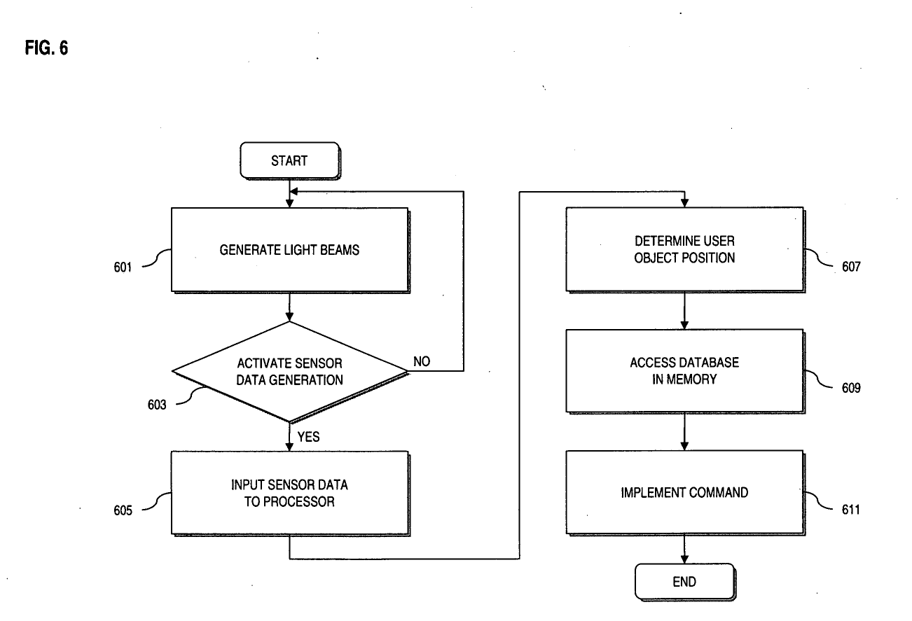

FIG. 6 is a flowchart exemplifying a typical mode of operation. The device is powered on at start and the light sources are activated to generate respective light beams at step 601. Step 601 may be initiated in response to another command from the processor in dependence on a particular mode of operation of the device that calls for user input, or may be active at any time in the powered mode.

At step 603, determination is made as to whether data representing sensed reflected light are to be input to the processor. For example, a triggering signal may be required to indicate user's placement at the desired location and selection is to be made, such as in the utilization of the two-dimensional template. (If, in another mode of operation, no triggering signal is required, step 603 may not be necessary.) If it is determined in step 603 that readout of the data produced by the light sensors is not to be activated, the flow chart reverts to step 601.

If it is determined at step 603 that sensed reflected light is to be used to activate a user input selection, the sensed data are input to the processor at step 605. The processor, at step 607, evaluates the received data to determine the spatial position of the object. This evaluation may lead to a determination of a linear position for one dimensional operational mode or a determination of a two-dimensional position in other modes of operation. At step 609, the processor accesses an appropriate data base in the memory to correlate the determined position of the object with the appropriate selected command. At step 611, the command is implemented by the processor. The flow chart process can end at this point or revert to step 601 for receipt of another user input.

In this disclosure there are shown and described only preferred embodiments of the invention and but a few examples of its versatility. It is to be understood that the invention is capable of use in various other combinations and environments and is capable of changes or modifications within the scope of the inventive concept as expressed herein. The use of reflected light as a user input, as described herein, may be used as an alternative to traditional user input implementations or in addition to user interfaces maintained by the user devices.

What is claimed is:

1. A method comprising:
generating a plurality of light beams from sources spaced from each other in a defined relationship;
imposing a user object within an area of the light generated in the generating step;
sensing light reflected from the user object;
correlating the light sensed in the sensing step with a predefined operation of a user device.

2. A method as recited in claim 1, further comprising performing the predefined operation in response to the step of correlating.

3. A method as recited in claim 2, wherein:
the step of generating comprises defining a unique characteristic for each of the light sources;
the step of sensing comprises identifying components of the reflected light having characteristics that correspond to respective light sources; and
the step of correlating comprises establishing relative magnitudes of the components of the reflected light.

4. A method as recited in claim 3, wherein the step of correlating further comprises:
determining a two-dimensional position of the object in accordance with the relative magnitudes of the reflected light components; and
identifying the predefined operation that corresponds to the position of the object.

5. A method as recited in claim 4, further comprising:
formulating a template containing a plurality of two-dimensional position indicia, each of the indicia corresponding to a respective user device operation; and
wherein the imposing step comprises employing the template by the user to position the object.

6. A method as recited in claim 5, wherein the object comprises the user's finger.

7. A method as recited in claim 4, further comprising displaying an image associated with the predefined operation that corresponds to the position of the object.

8. A method as recited in claim 2, wherein the step of sensing comprises:
accessing a plurality of light sensors spaced in correspondence with respective ones of the light sources;
identifying the light sensor that detects the greatest magnitude of reflected light with its corresponding light source; and
the correlating step comprises determining a predefined operation that corresponds to the identified light source.

9. A method as recited in claim 8, wherein:
the step of imposing comprises sweeping the object across a plurality of the light sources;
the step of identifying is applied to each of the plurality of light sources; and
the step of correlating comprises determining a predetermined operation that corresponds to the plurality of light sources identified.

10. A method as recited in claim 1, further comprising:
detecting a user input; and
wherein the step of sensing is triggered in response to the detection of the user input.

11. A method as recited in claim 10, wherein the detecting step comprises receiving an audible signal.

12. A method as recited in claim 10, wherein the detecting step comprises sensing a capacitive field.

13. Apparatus comprising:
an interactive user device embodied in a housing, the interactive device comprising a processor, a display, and a memory;
a plurality of light sources spaced from each other at an outer surface of the housing; and
at least one light sensor positioned at the surface of the housing;
wherein the at least one light sensor is configured to input data to the processor data that correspond to sensed light generated by any of the light sources and reflected by an imposed user object, and the processor is configured to correlate the input data with a predefined operation of the user device.

14. Apparatus as recited in claim 13, wherein the plurality of light sources in a linear configuration, and a plurality of light sensors, equal in number to the number of light sources, are configured in a linear direction parallel to the light sensors, each light sensor in proximity to a respective light source.

15. Apparatus as recited in claim 13, wherein each of the light sources is a light emitting diode of specific color.

16. Apparatus as recited in claim 13, wherein each of the light sources emanates light at a uniquely identifiable pulse rate.

17. Apparatus as recited in claim 13, wherein the housing further comprises a retractable template extendable in a lateral direction from the surface to an open position, the template having a planar surface perpendicular to the housing surface in the open position, and wherein the template surface contains a plurality of two-dimensional position indicia, each of the indicia corresponding to a respective user device operation.

18. Apparatus as recited in claim 17, wherein the template indicia correspond to a first set of device operations when the template is extended to a first position and correspond to a second set of device operations when the template is extended to a second position.

19. Apparatus as recited in claim 13, wherein each light source comprises an outer film through which a unique image can be projected.

20. Apparatus as recited in claim 13, wherein the interactive user device comprises a mobile phone.
